(19) United States
(12) Patent Application Publication
(10) Pub. No.: US 2025/0376624 A1
(43) Pub. Date: Dec. 11, 2025

(54) ROOM-TEMPERATURE SUPERFLUORESCENCE NANOCRYSTALS AND RELATED METHODS

(71) Applicants: North Carolina State University, Raleigh, NC (US); UNIVERSITY OF MASSACHUSETTS, Boston, MA (US)

(72) Inventors: Shuang Fang LIM, Raleigh, NC (US); Kory GREEN, Raleigh, NC (US); Hans HALLEN, Raleigh, NC (US); Gang HAN, Worcester, MA (US); Kai HUANG, Worcester, MA (US)

(21) Appl. No.: 19/107,811

(22) PCT Filed: Aug. 28, 2023
(86) PCT No.: PCT/US2023/073008

§ 371 Date: Feb. 28, 2025

Related U.S. Application Data
(60) Provisional application No. 63/401,703, filed on Aug. 28, 2022.

(51) Int. Cl. C09K 11/77

(52) U.S. Cl. CPC C09K 11/7773

(57) ABSTRACT

Various examples are provided related to superfluorescence (SF) at room temperature. In one example, an upconversion nanoparticle (UCNP) includes a nanocrystal lattice doped with a rare earth element, the rare earth element distributed in the nanocrystal lattice with a coupling distance that produces anti-Stokes shifted SF. The rare earth element can be a Nd³+ ion.

### CROSS REFERENCE TO RELATED APPLICATIONS

This application claims priority to, and the benefit of, U.S. provisional application entitled “ROOM-TEMPERATURE SUPERFLUORESCENCE NANOCRYSTALS AND RELATED METHODS” having Ser. No. 63/401,703, filed Aug. 28, 2022, which is hereby incorporated by reference in its entirety.

### STATEMENT REGARDING FEDERALLY SPONSORED RESEARCH OR DEVELOPMENT

This invention was made with government support under W911NF-21-1-0283 awarded by the Army Research Laboratory—Army Research Office. The government has certain rights in the invention.

### BACKGROUND

Superfluorescence (SF) is a distinctive optical phenomenon that consists of an ensemble of emitters coupling collectively to produce a short but intense burst of light. This quantum optical phenomenon is distinct from typical isotropic spontaneous emission or normal fluorescence. SF is a unique quantum mechanical behavior arising from the self-organization between emitters, thus forming a cooperatively coupled assembly. In contrast to isotropic spontaneous emission or normal fluorescence, SF produces a short but intense burst of light, which makes it ideal for a wide variety of applications in photonics, electronics, and optical computing. Due to the prerequisite of cooperative emitter coupling, SF has been conventionally observed under cryogenic conditions in limited systems, such as atomic gases, and a few bulk material systems.

### SUMMARY

Aspects of the present disclosure are related to superfluorescence (SF) at room temperature. SF is a unique quantum optics phenomenon arising from the assembly of self-organized and cooperatively coupled emitters. SF produces a short and intense burst of light, ideal for various applications in nanophotonics and optical computing. However, due to the prerequisite for cooperative emitter coupling, SF was conventionally observed in a Stokes-shifted manner under cryogenic conditions in limited systems (for example, atomic gases and perovskite-nanocrystal superlattices). Here it is shown that room-temperature anti-Stokes-shift SF can be achieved in a few randomly assembled or in a single lanthanide-doped upconversion nanoparticle. Moreover, upconverted SF has a 10,000-fold accelerated nanosecond lifetime (τ=46 ns of SF versus τ=455.8 μs for normal upconversion luminescence), overcoming the slow decay of conventional upconversion systems. Therefore, the conceptual room-temperature anti-Stokes-shift SF not only lays the foundation for ultrafast upconversion but it also paves a straightforward way to a wide variety of applications that have been limited by the existing SF system.

In one aspect, among others, an upconversion nanoparticle (UCNP) comprises a nanocrystal lattice doped with a rare earth element, the rare earth element distributed in the nanocrystal lattice with a coupling distance that produces anti-Stokes shifted superfluorescence (SF) at room temperature. In one or more aspects, the rare earth element can be a Nd³⁺ ion. The nanocrystal lattice can comprise Nd³⁺ ions at a dopant level of about 20% or greater. The Nd³⁺ ion dopant level can be about 90%. In various aspects, the UCNP can comprise a core; a connecting layer disposed about the core; and a SF layer disposed about the connecting layer, the SF layer comprising the nanocrystal lattice doped with the rare earth element. The core can comprise Yb³⁺. The core can comprise Er³⁺. The core can comprise Yb³⁺ and Er³⁺ and the connecting shell can comprise Yb³⁺. The core can be an upconversion core. The UCNP can comprise an inert-core configuration. The UCNP can comprise a Nd core-shell configuration. A burst duration of the SF can be less than 100 ns. The SF can be produced in response to near infrared excitation. The NIR excitation can be provided at 800 nm. The SF can be produced in a range from 500 nm to 700 nm.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A illustrates an example of the alignment of random dipoles resulting in the superfluorescence (SF) pulse, in accordance with various embodiments of the present disclosure.

FIG. 1B illustrates an example of upconverted SF from Nd³⁺-ion clustering in single upconversion nanoparticles (UCNPs), in accordance with various embodiments of the present disclosure.

FIG. 1C illustrates an example of a core-shell-shell (CSS) structure of a UCNP, in accordance with various embodiments of the present disclosure.

FIG. 1D illustrates an elemental mapping of the CSS UCNPs, in accordance with various embodiments of the present disclosure.

FIG. 1E includes scanning electron microscope (SEM) images of a CSS UCNPs assembly, in accordance with various embodiments of the present disclosure.

FIG. 1F illustrates an optical setup employed for SF characterization of a UCNP assembly or single UCNP nanocrystal, in accordance with various embodiments of the present disclosure.

FIG. 2A-2D illustrate examples of anti-Stokes-shift upconverted SF in CSS UCNP assembly, in accordance with various embodiments of the present disclosure.

FIGS. 3A-3C illustrate examples of UCL and SF spectrums of ISC, ND3+ and NdCS UCNPs, in accordance with various embodiments of the present disclosure.

FIGS. 3D and 3E illustrate examples of SF spectra and decays of CSS UCNPs with different Nd³⁺ doping concentrations, in accordance with various embodiments of the present disclosure.

FIG. 3F illustrates an example of a proposed energy transfer diagram for SF originating from Nd³⁺-ion-compacted UCNPs, in accordance with various embodiments of the present disclosure.

FIG. 3G illustrates power dependence of SF, in accordance with various embodiments of the present disclosure.

FIGS. 4A-4F illustrate examples of upconverted SF in a single UCNP nanocrystal, in accordance with various embodiments of the present disclosure.

### DETAILED DESCRIPTION

Disclosed herein are various examples related to superfluorescence (SF) at room temperature. Reference will now be made in detail to the description of the embodiments as illustrated in the drawings, wherein like reference numbers indicate like parts throughout the several views.

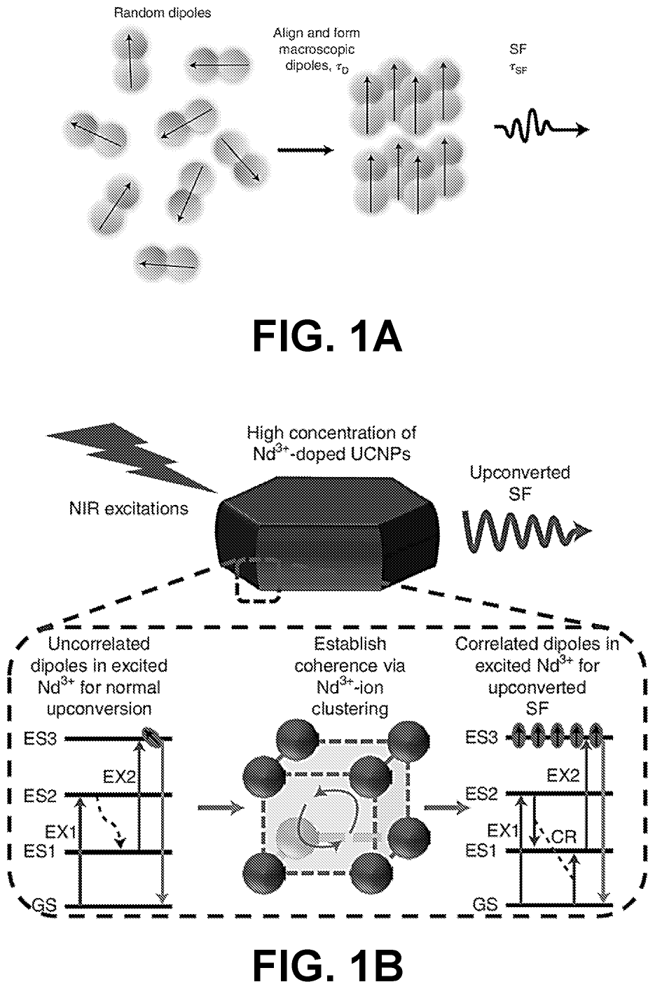

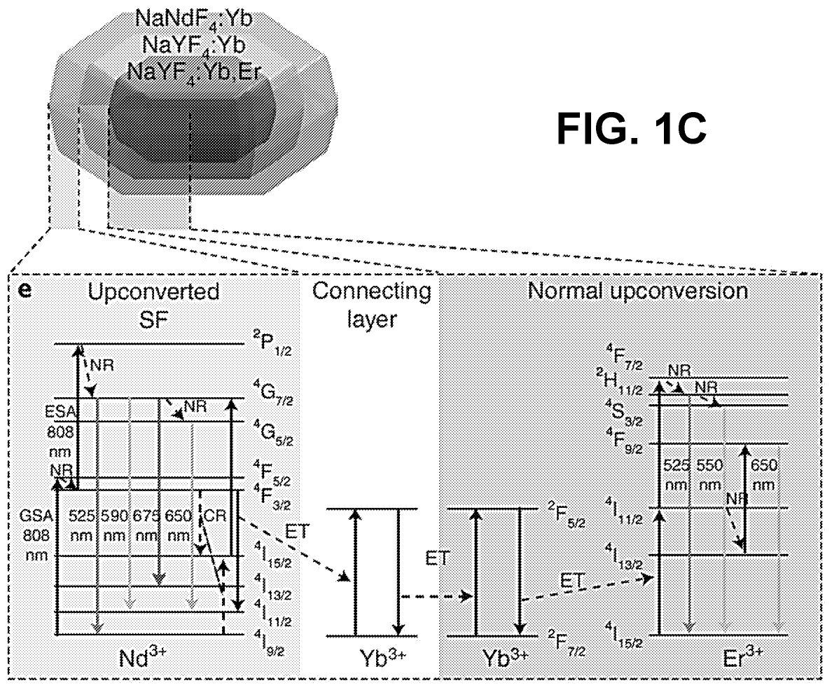

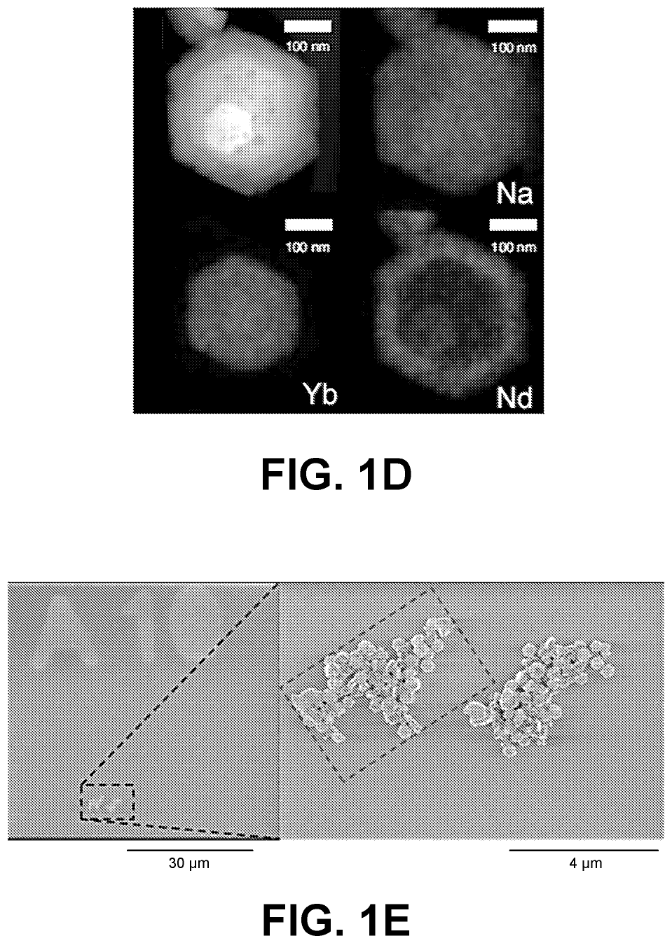

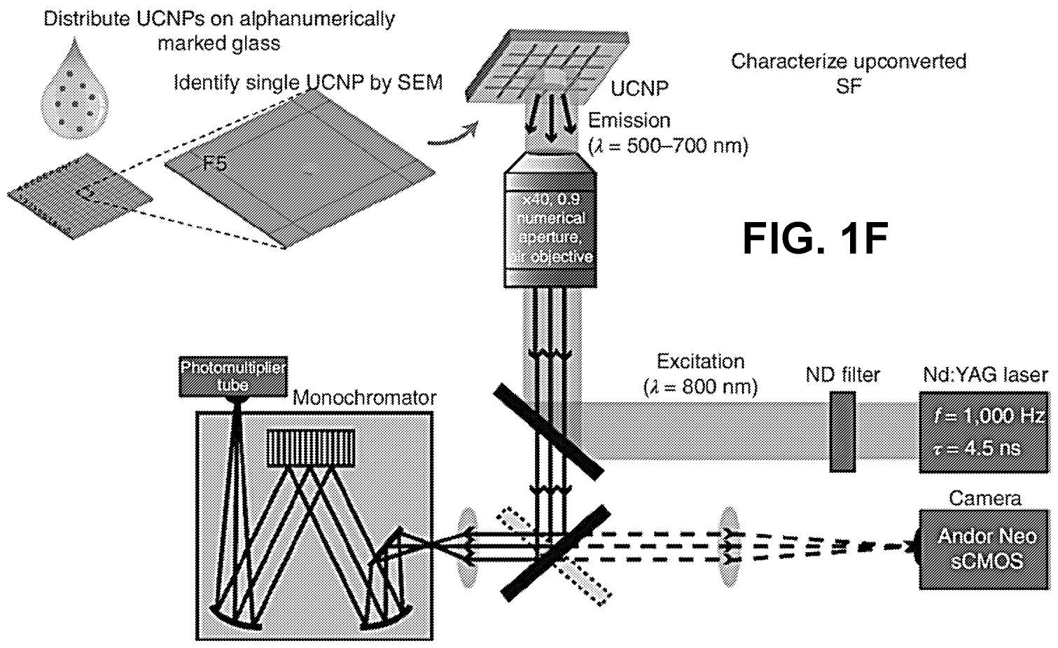

In SF, an external radiative field excites an initially incoherent energy level. The subsequent SF takes place only when a number of randomly oriented dipoles align spontaneously, giving rise to a single macroscopic dipole. FIG. 1A schematically illustrates an example of the alignment of random dipoles resulting in the SF pulse. The resultant macroscopic dipole moment is remarkably larger than the single-emitter dipole moment. Due to the coherently coupled emitters, the emission duration is, therefore, much shorter and the emission intensity is remarkably stronger. The SF emission typically has a pulse whose peak intensity scales as N² and a lifetime that scales as τ_{SF}≈τ_{SP}/N (where N is the number of aligned dipoles and τ_{SP} is the normal single-emitter spontaneous decay time). The unusual intrinsic nature of the rapid, intense and narrow spectral peaks in SF is fascinating and has been of considerable interest as an ideal optical mechanism for a wide variety of photonic applications, including lasing, multiphoton light resources, on-chip integration in optical computing and ultrafast biosensing.

Historically, the phenomenon of SF was first proposed to predict that coherent and cooperative spontaneous emission may theoretically exist in emitters confined at a volume of dimensions smaller than a wavelength. A greater distinction was made between superradiance and SF. Although superradiance has similar optical qualities to SF, it requires the direct excitation of an initially coherent macroscopic dipole. SF occurs from an initially incoherent energy level in emitters, whose population spontaneously aligns to build up a macroscopic dipole on excitation. Thus, this places fewer constraints on the preparation of SF media compared with the precoupling of dipoles to the excitation in superradiance. Nevertheless, since the first experimental observation of SF in dense hydrogen fluoride gas, SF has only been exclusively observed in a Stokes-shifted manner and has been limited to a few atomic gases and bulk material systems such as rarefied impurities in crystals, highly ordered superlattices of lead halide perovskite nanocrystals and stacked semiconductor quantum wells at high magnetic fields.

Moreover, all these Stokes-shift SF instances have been conventionally realized in cryogenic conditions (that is, at low temperatures of ˜6 to ˜100 K), thus also limiting their practical applications. In addition, the lack of SF at the single-nanocrystal level also hinders its applications, such as those for nanophotonics. For example, a reliable rapid SF burst from single nanocrystals can unleash the SF potential to develop high-speed optical computing, where each patterned single nanocrystal is a single optical light source and transistor that enables communication by the SF photons at the speed of light. Furthermore, the existing SF only takes place in a Stokes-shifted manner. No anti-Stokes-shift SF has been discovered in either an ensemble of nanoparticles or at the single-nanoparticle level. In particular, as a type of efficient anti-Stokes-shift luminescent material, lanthanide-doped upconversion nanoparticles (UCNPs) have attracted remarkable interest for imaging, sensing and photoactivation. However, the long radiative lifetime of conventional upconversion luminescence (UCL) at a scale of hundreds of microseconds considerably limits its applications in high-speed imaging and highly dynamic photoactivations. To accelerate such slow emissions in conventional UCNPs, finely fabricated cavities have been attempted but are complicated and the present fastest lifetime record, based on current knowledge, for such anti-Stokes-shift emission is 1.4 μs, which, however, is still not satisfactory for high-speed nanosecond-scale signaling as seen in traditional fluorescence materials. Therefore, developing a nanosecond-scale anti-Stokes-shift SF system under room temperature is desirable for both fundamental science and its practical applications. Here, a room-temperature anti-Stokes-shift SF from Nd³⁺-ion-compacted

lanthanide-doped UCNPs is disclosed. Compared with SF from highly ordered perovskite nanocrystals and semiconductor quantum dots assembly using each nanoparticle as an emitter, in lanthanide-doped UCNPs, each lanthanide ion in a single nanoparticle is an individual emitter that can interact with other lanthanide ions through the radiation field to establish coherence and to enable anti-Stokes-shift SF in both random nanoparticle assembly and single-nanocrystal level, the latter of which is one of the smallest-ever SF media. In particular, the coherence of Nd³⁺-ion emitters in ion-compacted crystals endows two unique advantages to realize SF at room temperature in terms of (1) less-disturbed 4f electron transitions and (2) extraordinary proximity of coupled emitters.

The coherence of Nd³⁺ ion-emitters in ion-compacted crystals endows two unique advantages to realize SF at room temperature, in terms of (1) less-disturbed 4f electron transitions, and (2) significant proximity of coupled emitters. First, the coherence of lanthanide ions takes place via electron transitions in their 4f orbitals, which are shielded by the outer-lying occupied 5s and 5p orbitals. This feature makes the coherence less disturbed by the surroundings and preserves long coherence time in lanthanide-doped luminescent materials. Second, Nd³⁺ ion compacted nanocrystals allow for a significantly shortened distance between individual emitters, which remarkably enhances coherence between emitters, considering that energy transfer is exponentially increasing with shortened distance. As a comparison, the superlattice of the perovskite quantum dot has a mean size of 9.5 nm of each quantum dot emitter. Such a long distance imposes challenges to the coupling of neighboring/second-neighboring emitters at room temperature. In contrast, in Nd³⁺ ion compacted-nanocrystals, the shortest and second-shortest emitter distances are 0.35 nm and 0.38 nm, respectively. Collectively, the characteristic 4f orbital-based coherence between extremely close Nd³⁺ ion-emitters collectively contributes to the unprecedented SF at room temperature. More importantly, this UCNP SF is photon upconverted, as it is excited by near-infrared (NIR) light at 800 nm and emits light at a shorter wavelength (for example, ˜590 nm). FIG. 1B schematically illustrates an example of the upconverted SF from Nd³⁺-ion clustering in single UCNPs.

In addition, the resultant UCNP SF was observed to have an extremely narrow spectral width at a single-nanocrystal level (full-width at half-maximum, 2 nm), as well as a remarkably shortened radiative decay lifetime (τ=46 ns, 10,000-fold faster than that of normal UCL, τ=455.8 μs). The ultrafast upconverted SF overcomes the current limitations of conventionally slow UCL lifetimes, which have constrained the imaging speed and are undesirable for highly dynamic tracking and imaging. Furthermore, unlike existing SF materials, SF can come from as-synthesized UCNPs and does not require any post-synthesis treatment or rely on any extraordinary operating conditions or prior macroscopic polarization. When coupled with its unique long-wavelength excitation, rapid, intense, and narrow spectral peaks of upconverted SF can be readily observed and culminated. Therefore, all the abovementioned advantages are highly desirable for nanophotonic applications that rely on rapid and monochromic signals for highly dynamic and fast processing.

In particular, the anti-Stokes-shift upconverted SF in Nd³⁺-ion-compacted (90%) hexagonal-phase UCNPs is reported on. Compared with conventional Yb³⁺-sensitized UCNPs, Nd³⁺-ions possess a much enhanced NIR absorption cross-section, thereby enhancing the efficient harvesting of excitation energy. Moreover, the close proximity of Nd³⁺ ions in such a highly Nd³⁺-doped nanocrystal lattice can lead to remarkably enhanced energy cross-relaxation (CR) between Nd³⁺-ions. Consequently, this CR enhancement effectively preserves the excitation energy and facilitates energy recycling among such a large number of adjacent Nd³⁺-ions. Such highly correlated Nd³⁺-ion clustering leads to the subsequent formation of a uniform macroscopic dipole for upconverted SF emission (see FIG. 1B). As a result, room-temperature (at 17° C. or 290 K, except otherwise stated) anti-Stokes-shift upconverted SF was successfully observed in a few (˜30) randomly dispersed nanoparticle assembly, and in a single nanoparticle of NaYF₄:Yb, Er@NaYF₄:Yb@NaNdF₄:Yb core-shell-shell (CSS) UCNP.

In these CSS UCNPs, a high concentration of Nd³⁺-ions at the 90% doping level in the outermost layer is responsible for the upconverted SF emission, and the core contains Yb³⁺ and Er³⁺ that primarily emit normal UCL, the inner shell is a connecting layer to bridge the excited energy from the outer shell to the core. FIG. 1C illustrates an example of the CSS structure of the UCNP and shows the energy-level diagram of Nd³⁺ transitions (ET: energy transfer; NR: nonradiative relaxation) involved in SF (shell layer) and normal UCL (core). FIG. 1D illustrates the elemental mapping of the CSS UCNPs. Such a CSS nanostructure provides an ultrahigh Nd³⁺ concentration within the outer shell to maximize CR and dipole-dipole interaction between closely spaced Nd³⁺-ion clusters for SF. At the same time, it also retains the normal UCL-emitting inner layers, allowing for the simultaneous comparison of SF and UCL within the same nanocrystal. The optical performance of an assembly of a few nanoparticles (˜30) was also characterized under 800 nm laser excitation. FIG. 1E shows scanning electron microscope (SEM) images of a CSS UCNPs assembly and FIG. 1F schematically illustrates the deposition of the UCNP assembly or single UCNP nanocrystals for SF characterization.

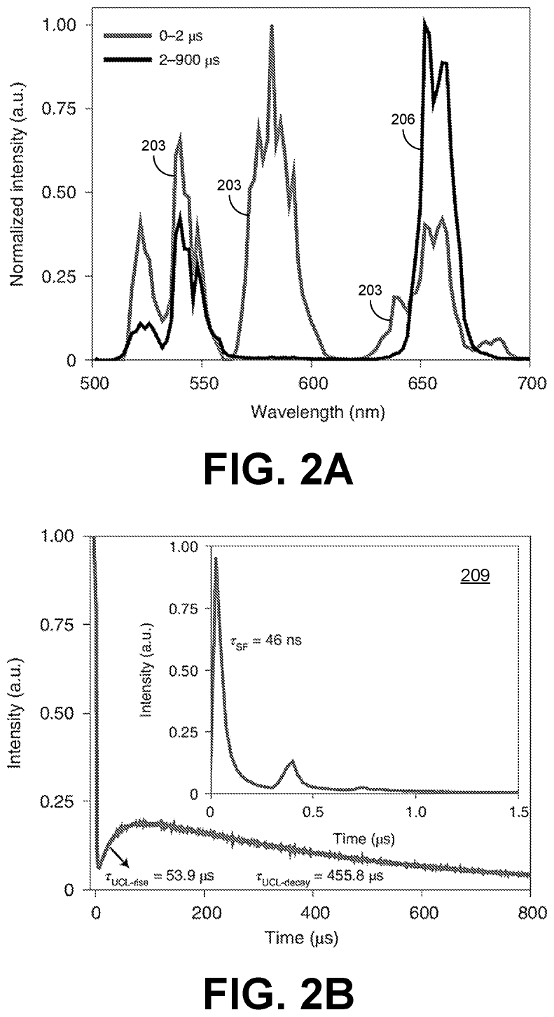

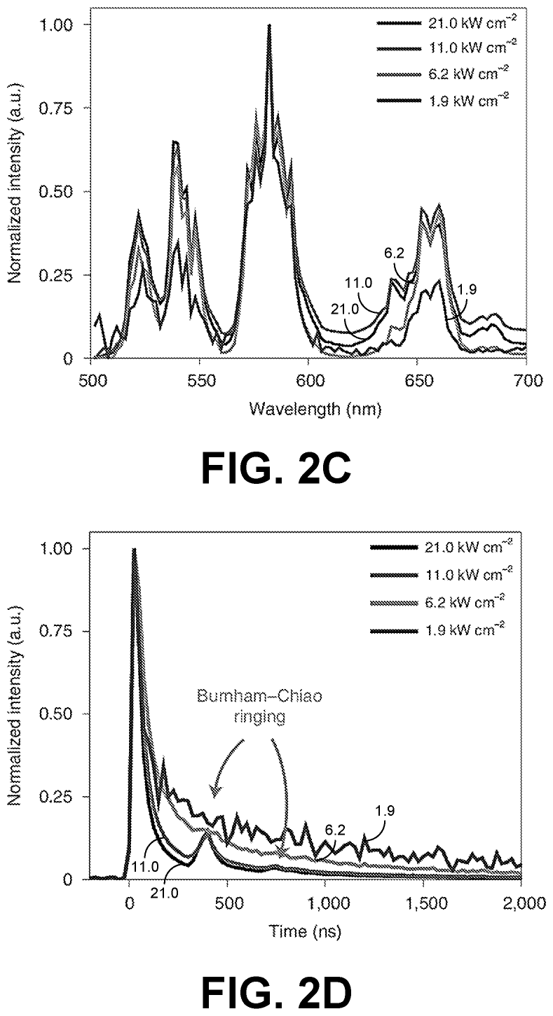

Two distinctive types of emission were observed with regard to emission lifetime. FIG. 2A illustrates an example of fast SF (203) and slow normal UCL (206) emission spectrum of CSS UCNPs: one recorded within 0-2 μs (203) and the other from 2 to 900 μs (206). The fast SF emission shows a prominent sharp peak at ˜590 nm, which is absent for the normal slow UCL. The ˜590 nm SF peak is attributed to the characteristic Nd³⁺ energy transition (⁴G_{7/2} to ⁴I_{11/2}). In addition, there are also other SF peaks that overlap with the peak locations of normal UCL in the long-lifetime region. These SF peaks can be assigned to the transitions within the Nd³⁺ ions or from the Er³⁺ ions that are pumped by the Nd³⁺ ions, including 525 nm (Nd³⁺, ⁴G_{7/2} to ⁴I_{9/2}; Er³⁺, ²H_{11/2} to ⁴I_{15/2}), 545 nm (Er³⁺, ⁴S_{3/2} to ⁴I_{15/2}), 652 nm (Nd³⁺, ⁴G^{5/2} to ⁴I_{11/2}; Er³⁺, ⁴F_{9/2} to ⁴I_{15/2}) and 675 nm (Nd³⁺, ⁴G_{7/2} to ⁴I_{13/2}). To compare the lifetimes of SF and normal UCL and since 652 nm emission is observed in both SF and normal UCL emissions, the time-resolved radiative decay dynamics were recorded at 652 nm. FIG. 2B shows the luminescence decay of 652 nm emission of CSS UCNPs showing both fast SF (τ_{SF}=46 ns) and slow normal UCL (τ_{UCL-decay}=455.8 μs) (the inset 209 shows the fine scanning of fast SF decay).

It showed an intense nanosecond-scale SF burst (τ_{SF}=46 ns) and a slower typical microsecond-scale UCL (τ_{UCL-rise}=53.9 μs and τ_{UCL-decay}=455.8 μs), with the SF decay being ˜10,000-fold faster than the normal UCL (τ_{SF}=46 ns versus τ_{UCL-decay}=455.8 μs). It is also remarkably faster than one of the fastest reported lifetimes recorded for UCNP materials (τ=1.4 μs), which is for coupled UCNPs with a fine-fabricated cavity. The fast SF emission at similar wavelengths was observed across a wide range of excitation power densities (from 1.9×10³ to 2.1×10⁴ W cm⁻²). FIG. 2C illustrates an example of the fast SF spectra of CSS UCNPs under different excitation power densities (normalized by the 590 nm SF intensity). In addition to the characteristic fast decay and sharp emission of SF, Burnham-Chiao ringing was also observed as a characteristic property of SF. FIG. 2D illustrates examples of fine scanning of fast SF at 590 nm showing Burnham-Chiao ringing under different excitation power densities. This is represented by the secondary and tertiary oscillatory peaks of smaller intensities occurring right after the main SF decay, which are apparently periodically occurring, with a time interval of ˜350 ns. It should be noted that oscillatory fluorescence may be attributed to the reabsorption of the initial emission, which can then be re-emitted and often observed as a train of pulses of decreasing height. Thus, the absence of an oscillatory peak under a lower excitation power density (1.9×10³ to 6.2×10³ W cm⁻²) may be attributed to the respective SF intensities that may not be intense enough for subsequent energy reabsorption and re-emission at weaker excitation (see FIG. 2D).

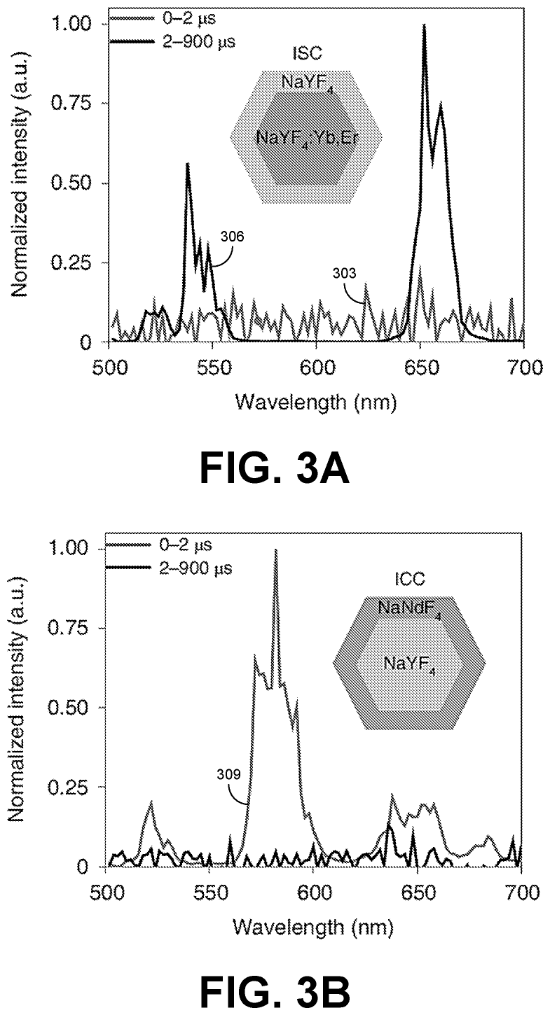

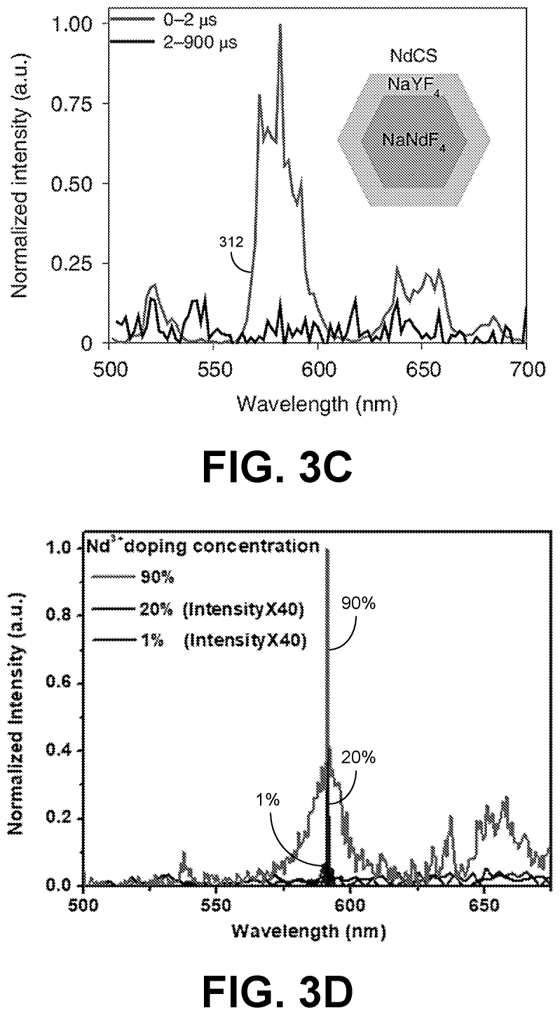

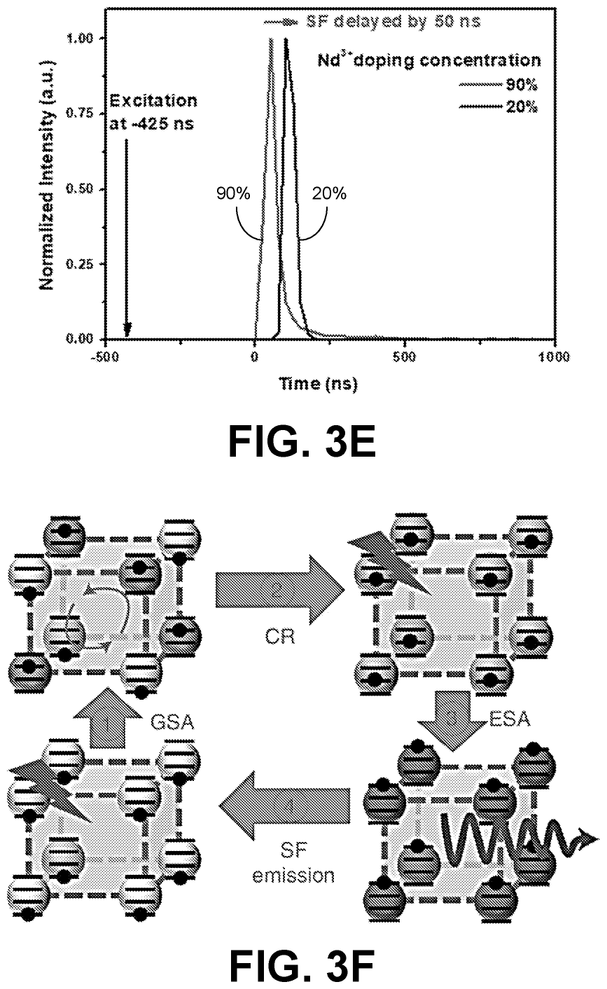

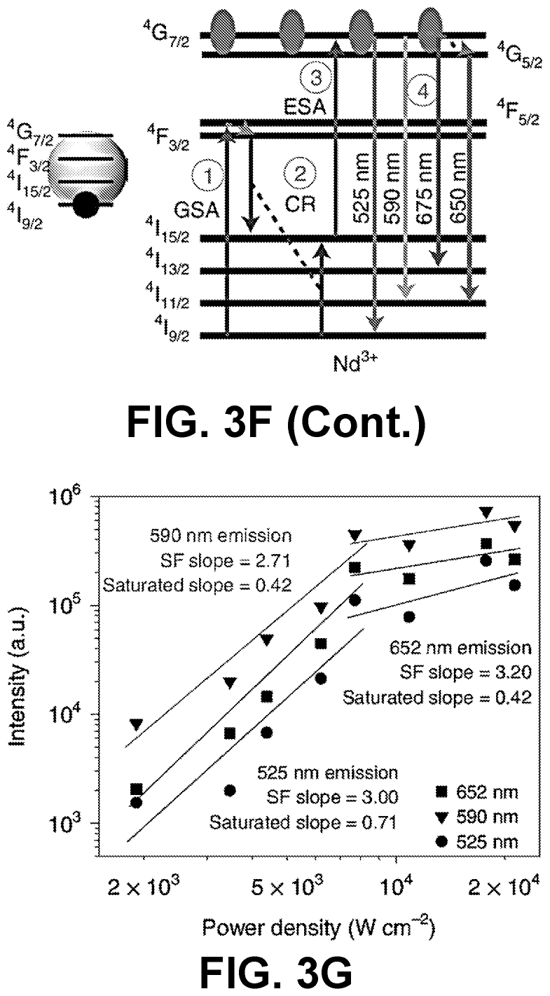

Furthermore, to explore the role played by Nd³⁺-ions in upconverted SF, a series of other Nd³⁺-doped heterostructured UCNPs were systematically investigated. In this regard, a negative control sample of a UCNP was first constructed without Nd³⁺ doping in the shell (inert-shell configuration (ISC) UCNP) (NaYF₄:Yb,Er@NaYF₄). As a result, SF emission was not found in such a control UCNP and only normal UCL was observed suggesting that the presence of the Nd³⁺-ion is a primary driving force and a necessary requirement for upconverted SF. FIG. 3A shows the lack of SF emission 303 and slow normal UCL spectrum 306 from ISC UCNP.

Furthermore, it was confirmed that upconverted SF can occur without the presence of Yb³⁺ and Er³⁺ ions. FIGS. 3B and 3C show the fast SF spectrums from ICC UCNPs and NdCS UCNPs, respectively. In this regard, the SF properties of the NaYF₄@NaNdF₄ UCNPs (inert-core configuration (ICC) UCNPs) and NaNdF₄@NaYF₄ UCNPs (Nd core-shell (NdCS) UCNPs) were synthesized and measured. With respect to ICC UCNPs, where Nd³⁺-ions were located in the shell layer, the spectrum clearly displayed upconverted SF at ˜590 nm (309 of FIG. 3B), as well as at the upconverted SF emission peaks of other Nd³⁺-originated electron transitions (˜525, ˜650 and ˜675 nm). For NdCS UCNPs, where Nd3+ ions were confined to inside the core, the upconverted SF properties were similar to that of the ICC UCNP (312 of FIG. 3C). Therefore, the results confirmed that the Nd³⁺ ion is the key to promote upconverted SF, and that the latter is independent of the location of Nd³⁺ in the nanocrystal and that it is spectrally distinct from normal UCL emission.

Next, it was confirmed that the SF is dependent on the doping density of Nd³⁺ in the nanocrystal. In addition to the highly doped (90% Nd³⁺ doping) CSS UCNPs and the negative-control ISC UCNPs with 0% Nd³⁺ doping, SF from CSS UCNPs was further tested with reduced Nd³⁺ doping at 20% and 1%. In CSS UCNPs with 20% Nd³⁺ doping, notably suppressed SF was observed, whose SF intensity is ˜1% of that of CSS UCNPs with 90% Nd³⁺ doping. FIG. 3D illustrates SF spectra of CSS UCNPs with different Nd³⁺ doping concentrations. This remarkable drop in SF intensity in such low Nd³⁺-packing nanocrystals is consistent with the exponentially decreased ion interactions along with an elongated ion distance. In addition to the notably suppressed SF intensity, a time delay of SF emission by 50 ns was also observed in the nanocrystal with 20% Nd³⁺ doping compared with that of 90% Nd³⁺ doping, indicating a longer duration for building up the coherency in sparser Nd³⁺-ion lattice. FIG. 3E shows a comparison of SF decay at 590 nm in CSS UCNPs with 90% and 20% Nd³⁺ doping concentrations. However, for 1% Nd³⁺ doping, the SF is undetectable due to inefficient coherency at room temperature in such an extremely loose Nd³⁺-ion lattice.

Based on the above observation, it was concluded that the observed SF was a consequence of the dipole self-organization aided by CR within the Nd³⁺-ion clusters. FIG. 3F illustrates an example of a proposed energy transfer diagram for SF originating from Nd³⁺-ion-compacted UCNPs. A possible energy transfer pathway can be as follows: when UCNPs are irradiated by 800 nm excitation light, an Nd³⁺-ion can be excited to the ⁴F_{5/2} state through a ground-state absorption (GSA) process, and it can be relaxed non-radiatively to the lower-lying ⁴F_{3/2} state via phonons (step 1). This excited Nd³⁺-ion can then transfer a fraction of its energy to a neighboring Nd³⁺-ion in the ion cluster during a CR process (step 2), populating the ⁴I_{15/2} intermediate state. Thereafter, the Nd³⁺-ion cluster was promoted to the ⁴G_{7/2} state through an excited-state absorption (ESA) process (step 3), providing the population inversion necessary for subsequent upconverted SF emission (step 4).

To verify that the upconverted SF originating from two-step photon absorption (steps 1 and 3), the power dependence of SF in CSS nanoparticles was measured. As expected, the CSS nanocrystals demonstrated a power dependence that fell into a range between 2.00 and 4.00 (3.00, 2.71 and 3.20 for ˜525, ˜590 and ˜652 nm emission, respectively). FIG. 3G illustrates the power dependence of SF with a slope between 2 and 4 in a lower-power range (note that in the higher-power range, the slope is between 0 and 1, indicating saturation of the excited states). Hence, the measurements are in agreement with the expected power dependence for SF, which is proportional to N²≈4 (N=2), where due to other energy-loss pathways, the experimentally determined power dependence was slightly lower. Note that the obtained power dependence between 2 and 4 can clearly distinguish SF from normal UCL; for UCL, the expected power dependence is ˜2 for a two-photon process.

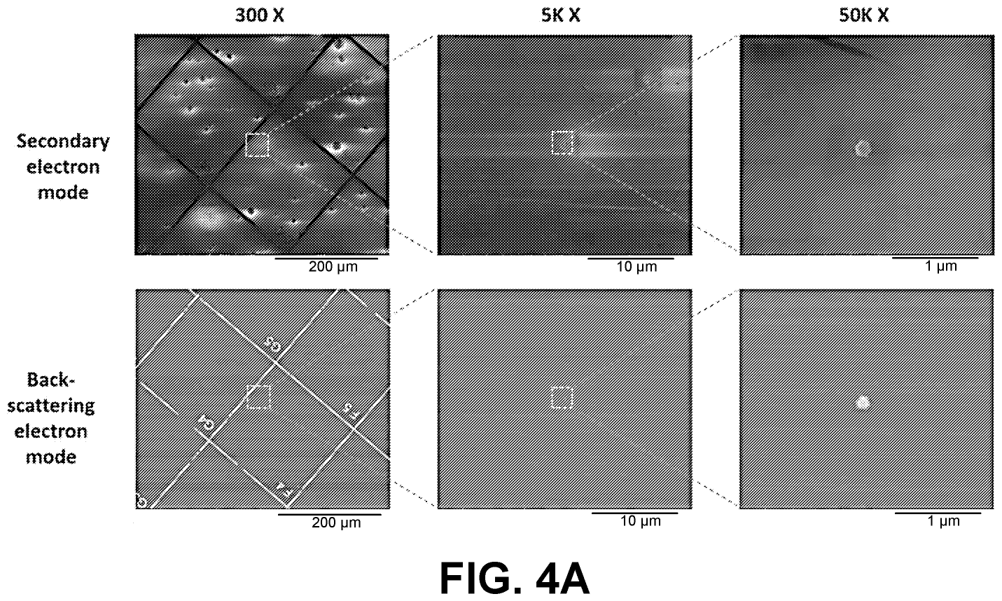

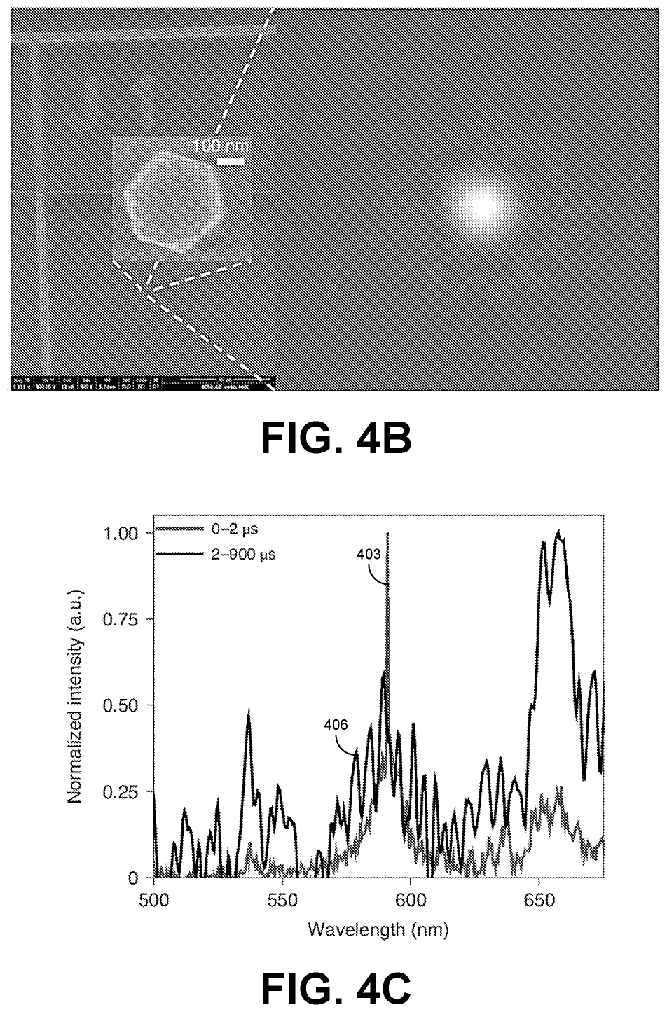

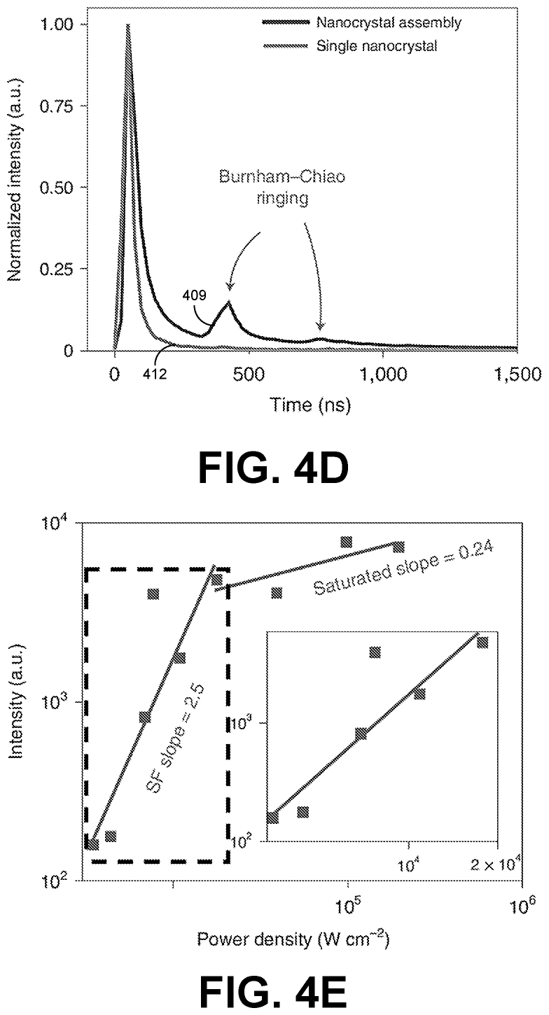

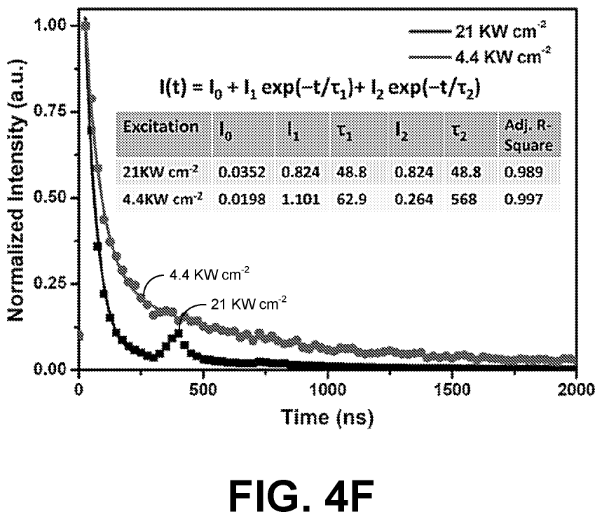

On discovering such room-temperature anti-Stokes-shift SF in UCNPs, it was explored whether SF can occur at the single-UCNP-nanoparticle level. The assembly shown in FIG. 1E was used for the examination of single UCNP nanocrystals. FIG. 4A illustrates representative SEM images showing identification of single UCNP distribution on the alphanumerically marked quartz glass slide, with every single UCNP isolated by >10 μm from each other. Both fast and slow emission from a single nanocrystal of CSS UCNP, despite the intensity being weaker due to a lower total number of emitters, compared with that of nanoparticle assembly. FIG. 4B is a scanning electron microscope (SEM) confirmation of the single-nanocrystal distribution and corresponding upconverted SF image. FIG. 4C illustrates an example of the single-nanocrystal spectra recorded from lifetime regions of 0-2 μs (403, upconverted SF) and 2-900 μs (406, UCL). Moreover, the fast emission (403), in contrast to the slower normal UCL (406), clearly shows an extremely sharp SF peak at ˜590 nm (full-width at half-maximum, 2 nm), which is also narrower than that in the nanoparticle assembly.

Such a sharp peak represents a desirable uniform macroscopic dipole in single nanocrystals, whereas the nanoparticle assembly suffers from spectral inhomogeneity due to the separate/independent dipole coherence in each individual nanocrystal. This SF in single nanocrystals shows a decay time of less than 50 ns, comparable to nanoparticle assembly. FIG. 4D illustrates a comparison of 590 nm decay of SF from nanoparticle assembly 409 and single nanocrystal 412. Within the room-temperature range, namely, from 13 to 21° C. (286 to 294 K), an obvious variation was not observed with regard to SF decay, but a slight redshift in the peak wavelength from the dimer nanoparticles was noticed. Since Burnham-Chiao ringing is based on reabsorption/re-emission at a large active volume, this phenomenon is absent in the case of single nanoparticles or closely contacted dimer or trimer nanoparticles.

Next, similar measurements were performed on ISC and ICC single nanocrystals, where rapid SF consistently occurred in ICC UCNP and is independent of size. Furthermore, the single-nanocrystal SF intensity at 590 nm versus the excitation power dependence was measured and gave rise to a slope of 2.5. It agreed with the nanoparticle assembly samples shown earlier, falling in line with the expected power dependence for SF that is proportional to N₂˜4 (where N=2). Compared with the respective power dependence number (2.7) in the nanoparticle assembly, the slightly lower number (2.5) of a CSS single nanocrystal is probably due to the increased energy losses in a single nanocrystal. FIG. 4E illustrates an example of power dependence of SF from single nanocrystal with a slope between 2 and 4 in the lower-power range (the inset shows a zoomed-in view of the boxed region). In a higher-power range, there is a saturation of excited states, whose slope is below 1.

To attain some insight into the number of emitters that contributed to SF, the different performances were examined with regard to the SF decay of CSS UCNPs at high and low excitation power densities. FIG. 4F illustrates an example of decay fitting of 590 nm emissions from CSS UCNPs at high and low excitation power densities. In contrast to emission at high excitation power (21 kW cm⁻²) displaying a single-component SF with lifetime τ_{SF}=˜50 ns, the emission at a low excitation power (4.4 kW cm⁻²) is a mixture of two components containing both SF (τ₁=63 ns, comparable to SF at high excitation) and a relatively slow emission (τ₂=568 ns). Assume that the relatively slow emission originates from the spontaneous emission of uncoupled emitters at weaker excitation. Based on the equation τ_{SF}∝τ_{SE}/N, where τ_{SE}=12 and N is the number of coupled emitters, the average number of coherently coupled emitters can be estimated as N≈11.

To test if this number of coupling emitters agrees with the doping rate, in a second way, it can be estimated using the number of ions within the longest possible coupling distance. Assuming that a doping concentration of 20% Nd³⁺ is the near-threshold doping concentration to realize SF at room temperature, it can be estimated that the longest possible ion distance to preserve effective coherence is 0.91 nm in this nanocrystal. Within such a volume, the number of Nd³⁺-ions is N=8.6 with 90% doping rate. The elongated Nd³⁺ ion separation in 20% doping nanocrystal compared to 90% doping nanocrystal was estimated as follows. The probability of energy transfer PET between two neighboring Nd³⁺ can be expressed as:

$${P}_{ET} = {C}_{Nd - Nd} \times {e}^{- 2 R / L} ;$$

where R is the effective separation between two neighboring Nd³⁺, C_{Nd-Nd} is a constant for Nd-Nd interaction, and L is the effective Bohr radius (L can be estimated to be ˜0.3 Å or 0.03 nm for Nd³⁺). The measurement indicates that 90% Nd³⁺ doping nanocrystal produced ˜100 times enhanced SF compared to 20% Nd³⁺ doping nanocrystal. Therefore,

$${P}_{ET ( 90 \% )} / {P}_{ET ( 20 \% )} = ( {C}_{Nd - Nd} \times {e}^{- 2 {R}_{90 \%} / L} ) / ( {C}_{Nd - Nd} \times {e}^{- 2 {R}_{20 \%} / L} ) = 100$$

$${e}^{2 ( {R}_{20 \%} - {R}_{90 \%} ) / L} = 100 ;$$

$${R}_{20 \%} - {R}_{90 \%} = ln 100 \times \frac{L}{2} = 0.07 nm ;$$

It indicates that, with a lower doping density, 20% Nd³⁺ doping nanocrystal possess an elongated effective Nd³⁺ separation by 0.07 nm compared to that of 90% Nd³⁺ doping nanocrystal. This elongated Nd³⁺ separation is consistent with the time delay of SF to building up coherency in sparser lattice. This is consistent with the number of emitters (N≈11) estimated by luminescence decay. Note that the slightly greater N value estimated by decay indicates the presence of possible SF in nanocrystals with even lower Nd³⁺ concentrations than the near-threshold concentration of 20%.

In summary, room-temperature anti-Stokes-shift upconverted SF is disclosed in both random assembly and single nanocrystals in as-synthesized Nd³⁺-ion-compacted UCNPs. Rather than using each nanoparticle as an emitter in the existing SF medium, such as perovskite-nanocrystal superlattice and semiconductor quantum dot assembly, each lanthanide ion in a single UCNP serves an individual emitter that can interact to establish coherence and to emit anti-Stokes-shift SF. The proximity of Nd³⁺-ions enhances dipole-dipole interactions, resulting in coherent collective oscillations, and the ensuing room-temperature anti-Stokes-shift SF emission under NIR excitation. Moreover, the ultrafast upconverted SF at a timescale of tens of nanoseconds overcomes the current limitations of conventionally slow microsecond UCL lifetimes, which are in conflict with the demand for a highly dynamic tracking and imaging process. Furthermore, upconverted SF comes from as-synthesized UCNPs and is exempted from any post-synthesis treatment, extraordinary operating conditions or prior macroscopic polarization, making it versatile and less constrained for broader application scenarios. Therefore, such conceptual room-temperature anti-Stokes-shift SF discovery should not only lay a new foundation to develop ultrafast upconversion materials but also pave the way to establish a new SF medium that can be explored in a wide variety of practical applications that have been constricted by existing optical materials.

### METHODS

Materials. Y₂O₃ (99.99%), Yb₂O₃ (99.99%), Tm₂O₃ (99.99%), Er₂O₃ (99.99%), Nd₂O₃ (99.99%), CF₃COONa (99.9%), CF₃COOH (99%), 1-octadecene (90%) and oleic acid (90%) were purchased from Sigma-Aldrich and used without further purification.

UCNP synthesis. Preparation of lanthanide trifluoroacetate precursors. The lanthanide trifluoroacetate precursors were prepared by dissolving lanthanide oxides in refluxing trifluoroacetic acid (CF₃COOH) solution. In a typical preparation of Y (CF₃COO)₃, 25 mmol Y₂O₃ was mixed with 200 mmol CF₃COOH and 15 ml H₂O (equal volume of CF₃COOH) in a three-neck round-bottom flask. The mixture was heated to 110° C. and kept refluxing with a water-cooling condenser for 8 h until the solution became clear. The refluxing apparatus was then removed to allow excess solution to be evaporated. The solid was kept in an 80° C. oven overnight and then milled into a fine powder with a mortar. The stock Y(CF₃COO)₃ powder was stored in a desiccator for UCNP synthesis. Trifluoroacetates of other lanthanide ions were prepared using the same method, except by changing the lanthanide oxides.

Synthesis of β-Na YF₄:40% Yb,2%Er core UCNPs. The β-NaYF₄:40% Yb,2%Er core UCNPs were prepared by a two-step thermolysis method. In the first step, CF₃COONa (0.50 mmol), Y(CF₃COO)₃ (0.29 mmol), Yb(CF₃COO)₃ (0.20 mmol) and Er(CF₃COO)₃ (0.01 mmol) precursors were mixed with oleic acid (5.00 mmol), oleyamine (5.00 mmol) and 1-octadecene (10.00 mmol) in a two-neck round-bottom flask. The mixture was heated to 110° C. to form a transparent solution followed by 10 min of degassing. Then, the mixture was heated to 300° C. at a rate of 15° C. min₋₁ under dry argon flow, and maintained at 300° C. for 30 min to form the α-NaYF₄:40% Yb,2%Er intermediate UCNPs. After the mixture cooled to room temperature, the α-NaYF₄:40% Yb,2%Er intermediate UCNPs were collected by centrifugal washing with excessive ethanol (7,500×g, 30 min). In the second step, the α-NaYF₄:40% Yb,2%Er intermediate UCNPs were redispersed into oleic acid (10.0 mmol) and 1-octadecene (10.0 mmol) together with CF₃COONa (0.5 mmol) in a new two-neck round-bottom flask. After degassing at 110° C. for 10 min, this flask was heated to 325° C. at a rate of 15° C. min−1 under dry argon flow, and maintained at 325° C. for 30 min to complete the phase transfer from α to β. After the mixture cooled to room temperature, β-NaYF4:40% Yb,2%Er UCNPs were collected by precipitating with an equal volume of ethanol and centrifugation afterwards (7,500×g, 30 min). The β-NaYF₄:40% Yb,2%Er UCNPs were stored in hexane (10 ml).

Synthesis of β-NaYF₄:40% Yb,2%Er@NaYF₄:20% Yb core-shell UCNPs. In this thermolysis reaction, the as-synthesized β-NaYF₄:40% Yb,2%Er core UCNPs served as the cores for the epitaxial growth of core-shell UCNPs. Typically, a hexane stock solution of β-NaYF₄:40% Yb,2% Er core UCNPs was transferred into a two-neck round-bottom flask, and hexane was sequentially evaporated by heating. CF₃COONa (0.50 mmol), Y(CF₃COO)₃ (0.40 mmol) and Yb(CF₃COO)₃ (0.10 mmol) were introduced as UCNP shell precursors with oleic acid (10.00 mmol) and 1-octadecene (10.00 mmol). After 10 min of degassing at 110° C., the flask was heated to 325° C. at a rate of 15° C. min−1 under dry argon flow, and maintained at 325° C. for 30 min to complete the shell crystal growth. After the mixture cooled to room temperature, the β-NaYF₄:40% Yb,2%Er@NaYF₄:20% Yb core-shell UCNPs were collected by precipitating with an equal volume of ethanol and centrifugation afterwards (7,500×g, 30 min). The β-NaYF₄:40% Yb,2%Er@NaYF₄:20% Yb core-shell UCNPs were stored in hexane (10 ml).

Synthesis of β-NaYF₄:40% Yb,2%Er@NaYF₄:20% Yb@NaNdF₄:10% Yb CSS UCNPs. In this thermolysis reaction, the as-synthesized β-NaYF₄:40% Yb,2%Er@NaYF₄:20% Yb core-shell UCNPs served as the cores for the epitaxial growth of shell crystal. Typically, a hexane stock solution of β-NaYF₄:40% Yb,2%Er@NaYF₄:20% Yb core-shell UCNPs was transferred into a two-neck round-bottom flask, and hexane was sequentially evaporated by heating. CF₃COONa (0.50 mmol), Nd (CF₃COO)₃ (0.45 mmol) and Yb (CF₃COO)₃ (0.05 mmol) were introduced as UCNP shell precursors with oleic acid (10.00 mmol) and 1-octadecene (10.00 mmol). After 10 min of degassing at 110° C., the flask was heated to 325° C. at a rate of 15° C. min−1 under dry argon flow, and maintained at 325° C. for 30 min to complete the shell crystal growth. After the mixture cooled to room temperature, the β-NaYF₄:40% Yb,2%Er@NaYF₄:20% Yb@NaNdF₄:10% Yb CSS UCNPs were collected by precipitating with an equal volume of ethanol and centrifugation afterwards (7,500×g, 30 min). The β-NaYF₄:40% Yb,2%Er@NaYF₄:20% Yb@NaNdF₄:10% Yb CSS UCNPs were stored in hexane (10 ml) for subsequent experiments.

NaYF₄:Yb,Er@NaYF₄, NaYF₄@NaNdF₄ and NaNdF₄@NaYF₄ UCNPs were similarly synthesized but the composition of core and shell precursors were adjusted.

Surface cleaning of UCNPs by NOBF₄. Take 10 mg UCNPs (2 ml) and add 3 ml hexane. Take 0.2 g nitrosonium tetrafluoroborate (NOBF4) and dissolve in 5 ml dimethylformamide. Mix these two solutions and vortex or stir overnight. Leave the mixture standing for 5 min, and they separate into two layers. Use a pipette to take the bottom-layer solution and add 5 ml ethanol. Centrifuge at 7,500×g for 30 min and carefully pipette out the supernatant. Add 5 ml dimethylformamide to disperse the pellets by sonication and shake for 2 min. Add 5 ml ethanol into the solution and centrifuge at 7,500×g for 30 min. Carefully pipette out the supernatant. Disperse the pellets in 10 ml pure ethanol (1 mg ml−1) by sonication and shake for 2 min.

Material characterization. The morphology of the samples was examined using a transmission electron microscope (Tecnai) at accelerating voltages of 120 kV. Elemental mapping was performed using a JEM-1200EX II transmission electron microscope.

UCNP distribution on glass slide and SEM characterization. For distributing UCNP assembly on a glass slide, the UCNP ethanol solution was dropped on an alphanumerically marked quartz glass slide. The position of the UCNP assembly was identified by viewing the glass slide under scanning electron microscopy (SEM; FEI Quanta 200 FEG MKII) with an accelerating voltage of 8 keV. An image magnified 12,000 times was used to clearly see the UCNP assemble, and an image magnified 1,300 times was used to identify the location of the assembly on the alphanumerically marked quartz glass slide. For distributing a single UCNP on the glass slide, the UCNP ethanol solution was diluted to 0.5 μg ml⁻¹. The solution was blown onto the alphanumerically marked quartz glass slide by high-speed pumped air. The slide was imaged via SEM at an accelerating voltage of 8 keV. An image magnified 50,000 times was used to confirm a single UCNP sitting on the slide, an image magnified 5,000 times was used to confirm that a single UCNP was isolated for >10 μm from the other UCNPs and an image magnified 300 times was used to identify the location of the single UCNP on the alphanumerically marked quartz glass slide.

SF characterization. The SF of the UCNP assembly or single UCNP on a glass slide was characterized by a fluorescence microscope equipped with an 800 nm pulsed laser. All the spectral and time-resolved data were collected using a microscope with a ×40, 0.9 numerical aperture air objective. The optical setup employed is shown in FIG. 1E. Excitation was provided by a Nd:YAG-pumped optical parametric oscillator purchased from Ekspla (NT253-1K-SH-H) tuned to 800 nm and pulsed at 1 KHz to provide sufficient decay time between pulses. Pulses had a pulse width of 4.5 ns. Temperature of the measurement was controlled by a thermoelectric Peltier attached to the sample holder. The laser pulses were cleaned up spectrally with a 700 nm long-pass filter and the output from the objective into the microscope was passed through a 700 nm short-pass filter to eliminate the laser background. Light was collected by a single-photon-counting detector (Hamamatsu H7421-40 photomultiplier) utilizing a half-metre monochromator for wavelength separation. Time dependence was performed using a field-programmable gate array card correlating the relative timing of the photomultiplier single-photon pulses to the Nd:YAG Q-switch signal output. A direct measurement of laser backscatter was used to determine the arrival time of laser pulses on the sample surface for determining the zero time of the decay measurements.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. An upconversion nanoparticle (UCNP), comprising:
a nanocrystal lattice doped with a rare earth element, the rare earth element distributed in the nanocrystal lattice with a coupling distance that produces anti-Stokes shifted superfluorescence (SF) at room temperature.

2. The UCNP of claim 1, wherein the rare earth element is a Nd³⁺ ion.

3. The UCNP of claim 2, wherein the nanocrystal lattice comprises Nd³⁺ ions at a dopant level of about 20% or greater.

4. The UCNP of claim 3, wherein the Nd³⁺ ion dopant level is about 90%.

5. The UCNP of claim 1, comprising:
a core;
a connecting layer disposed about the core; and
a SF layer disposed about the connecting layer, the SF layer comprising the nanocrystal lattice doped with the rare earth element.

6. The UCNP of claim 5, wherein the core comprises Yb³⁺.

7. The UCNP of claim 5, wherein the core comprises Er³⁺.

8. The UCNP of claim 5, wherein the core comprises Yb³⁺ and Er³⁺ and the connecting shell comprises Yb³⁺.

9. The UCNP of claim 5, wherein the core is an upconversion core.

10. The UCNP of claim 1, wherein the UCNP comprises an inert-core configuration.

11. The UCNP of claim 1, wherein the UCNP comprises a Nd core-shell configuration.

12. The UCNP of claim 1, wherein a burst duration of the SF is less than 100 ns.

13. The UCNP of claim 1, wherein the SF is produced in response to near infrared excitation.

14. The UCNP of claim 13, wherein the NIR excitation is provided at 800 nm.

15. The UCNP of claim 1, wherein the SF is produced in a range from 500 nm to 700 nm.
